(19) United States
(12) Patent Application Publication
(10) Pub. No.: US 2016/0342646 A1
(43) Pub. Date: Nov. 24, 2016

(54) DATABASE QUERY CURSOR MANAGEMENT

(71) Applicant: International Business Machines Corporation, Armonk, NY (US)

(72) Inventors: Shawn J. Baranczyk, Rochester, MN (US); Rafal P. Konik, Oronoco, MN (US); Roger A. Mittelstadt, Byron, MN (US); Brian R. Muras, Otsego, MN (US)

(21) Appl. No.: 14/717,311

(22) Filed: May 20, 2015

(51) Int. Cl. G06F 17/30

(52) U.S. Cl. CPC G06F 17/30442; G06F 17/30504

(57) ABSTRACT

Disclosed aspects include managing a query cursor. Based on a first query having a first Structured Query Language (SQL) syntax, a first query cursor is established. A second query is detected. The second query has a second SQL syntax which differs from the first SQL syntax. Based on a relationship of the second query with respect to the first query cursor, a determination is made to use the first query cursor to provide a valid results-set for the second query. Using the first query cursor, the valid results-set for the second query is provided.

### BACKGROUND

This disclosure relates generally to database management systems and, more particularly, relates to database queries. Databases are used to store information for numerous types of applications. Examples include various industrial, commercial, technical, scientific, and educational applications. Database management systems (DBMSs) are a typical mechanism for accessing data stored in a database. DBMSs are typically configured to separate the process of storing data from accessing, manipulating, or using data stored in a database. DBMSs often require tremendous resources to handle the heavy workloads placed on such systems. As such, it may be useful to increase the performance of database management systems with respect to processing searches, or queries, to databases.

### SUMMARY

Aspects of the disclosure allow different queries to use the same query cursors which may be derived from different jobs. Such aspects may have performance or efficiency benefits with respect to create cursor and optimization processing resources. Aspects include using an existing cursor cache with queries which have different syntax (e.g., syntactically and semantically different queries). For example, a first query may have an order-by portion, but a second query may not have an order-by portion. As such, the first cursor can be used for both different queries because they can return the same result set.

Disclosed aspects include managing a query cursor. Based on a first query having a first Structured Query Language (SQL) syntax, a first query cursor is established. A second query is detected. The second query has a second SQL syntax which differs from the first SQL syntax. Based on a relationship of the second query with respect to the first query cursor, a determination is made to use the first query cursor to provide a valid results-set for the second query. Using the first query cursor, the valid results-set for the second query is provided.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates an example representation of a computer system connected to a client computer via a network according to an embodiment;

FIG. 2 illustrates an example database management system (DBMS) according to an embodiment;

FIG. 3 is a flowchart illustrating a method for query cursor management according to embodiments;

FIG. 4 is a flowchart illustrating a method for query cursor management according to embodiments;

FIG. 5 is a flowchart illustrating a method for query cursor management according to embodiments; and

FIG. 6 shows an example system for query cursor management according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the disclosure allow different queries to use the same query cursors which may be derived from different jobs. Such aspects may have performance or efficiency benefits with respect to create cursor and optimization processing resources. Aspects include using an existing cursor cache with queries which have different syntax (e.g., syntactically and semantically different queries). For example, a first query may have an order-by portion, but a second query may not have an order-by portion. As such, the first cursor can be used for both different queries because they can return the same result set.

Aspects of the disclosure include a method, system, and computer program product for query cursor management. Query cursor management can include utilizing one or more established query cursors to process a job or query. A first query cursor is established based on a first query. The first query has a first Structured Query Language (SQL) syntax. A second query that has a second SQL syntax is detected. The second SQL syntax differs from the first SQL syntax. For example, the first SQL syntax may include a specific ordering component which is absent in the second SQL syntax. In certain embodiments, the second SQL syntax may have a set of ordering components which are all included in the first SQL syntax (though the second SQL syntax differs from the first SQL syntax).

Aspects include determining to use the first query cursor to provide a valid results-set for the second query. The determination is made based on a relationship of the second query with respect to the first query cursor. For example, if the first query cursor includes a first feature and if the second query includes a second feature, then the relationship may include the first feature matching the second feature. Using the first query cursor, the valid results-set for the second query is provided.

Aspects of the disclosure include various embodiments with respect to the first query cursor and the second query. For instance, the first query cursor may include a set of group-by fields having a first order, the second query may include the set of group-by fields having a second order, and the first order mismatches the second order. In certain embodiments, both the first query cursor and the second query include a same subquery or a same user-defined function. Altogether, aspects of the disclosure may deliver performance or efficiency benefits (e.g., saving create cursor or optimization processing resources) by allowing a job/query to use established query cursors (e.g., from a different job/query).

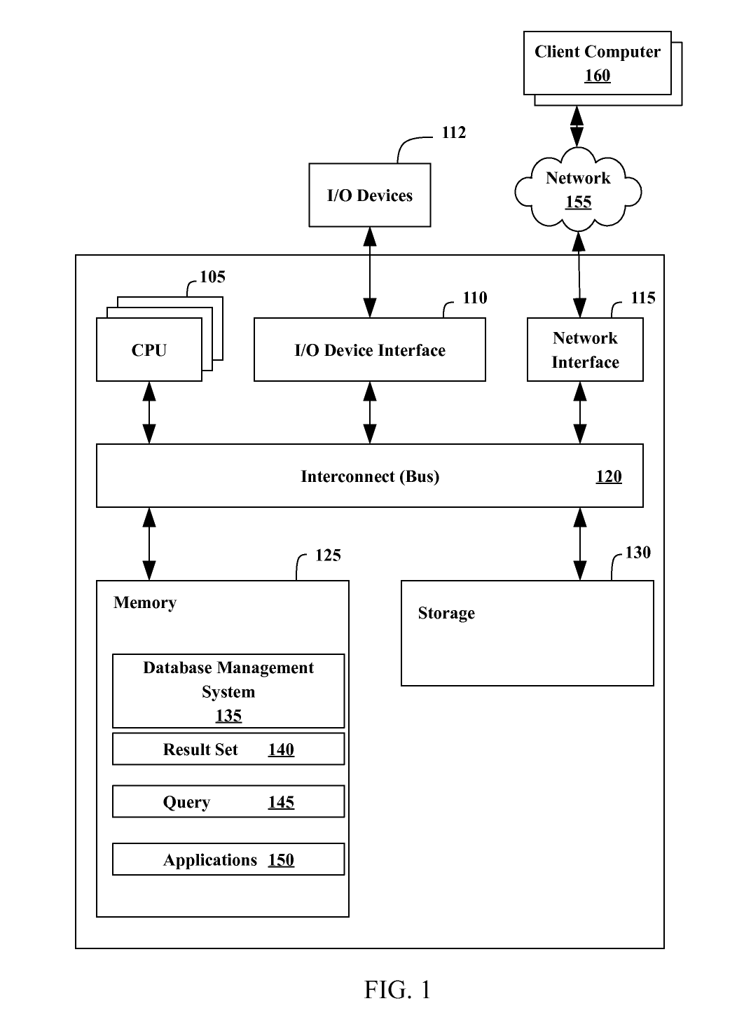

FIG. 1 illustrates an example representation of a computer system 100 connected to one or more client computers 160 via a network 155, according to some embodiments. For the purposes of this disclosure, computer system 100 may represent practically any type of computer, computer system, or other programmable electronic device, including but not limited to, a client computer, a server computer, a portable computer, a handheld computer, an embedded controller, etc. In some embodiments, computer system 100 may be implemented using one or more networked computers, e.g., in a cluster or other distributed computing system.

The computer system 100 may include, without limitation, one or more processors (CPUs) 105, a network interface 115, an interconnect 120, a memory 125, and a storage 130. The computer system 100 may also include an I/O device interface 110 used to connect I/O devices 112, e.g., keyboard, display, and mouse devices, to the computer system 100.

Each processor 105 may retrieve and execute programming instructions stored in the memory 125 or storage 130. Similarly, the processor 105 may store and retrieve application data residing in the memory 125. The interconnect 120 may transmit programming instructions and application data between each processor 105, I/O device interface 110, network interface 115, memory 125, and storage 130. The interconnect 120 may be one or more busses. The processor 105 may be a single central processing unit (CPU), multiple CPUs, or a single CPU having multiple processing cores in various embodiments. In one embodiment, a processor 105 may be a digital signal processor (DSP).

The memory 125 may be representative of a random access memory, e.g., Static Random Access Memory (SRAM), Dynamic Random Access Memory (DRAM), read-only memory, or flash memory. The storage 130 may be representative of a non-volatile memory, such as a hard disk drive, solid state device (SSD), or removable memory cards, optical storage, flash memory devices, network attached storage (NAS), or connections to storage area network (SAN) devices, or other devices that may store non-volatile data. The network interface 115 may be configured to transmit data via the communications network 155.

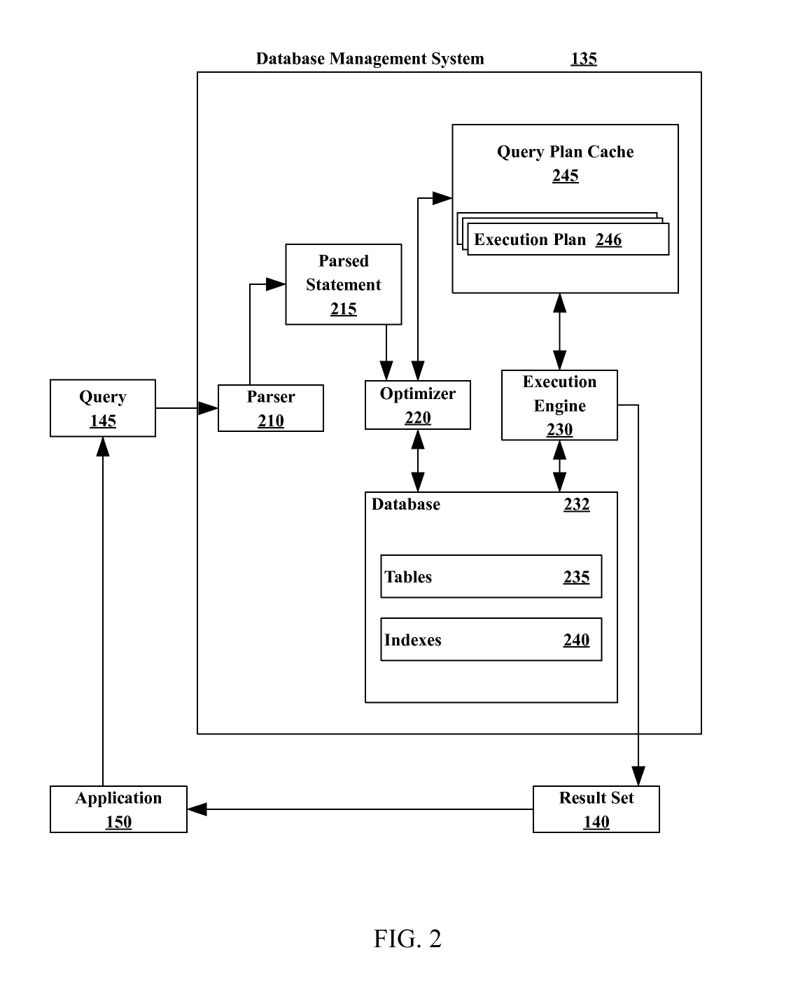

The memory 125 may include a database management system (DBMS) 135, a result set 140, a query 145, and applications 150. Although these elements are illustrated as residing in the memory 125, any of the elements, or combinations thereof, may reside in the storage 130 or partially in the memory 125 and partially in the storage 130. Each of these elements will be described in greater detail in accordance with FIG. 2.

The network 155 may be any suitable network or combination of networks and may support any appropriate protocol suitable for communication of data and/or code to/from the server computer system 100 and the client computer system 160. In some embodiments, the network 155 may support wireless communications. In other embodiments, the network 155 may support hardwired communications. The network 155 may be the Internet and may support Internet Protocol in some embodiments. In other embodiments, the network 155 may be implemented as a local area network (LAN) or a wide area network (WAN). The network 155 may also be implemented as a cellular data network. Although the network 155 is shown as a single network in the figures, one or more networks of the same or different types may be included.

The client computer system 160 may include some or all of the hardware and software elements of the computer system 100 previously described. As shown, there may be one or more client computers 160 connected to the computer system 100 via the network 155. In some embodiments, one or more client computers 160 may send a query 145 by network 155 to computer system 100 and receive a result set 140.

FIG. 2 illustrates an example database management system (DBMS) 135. The DBMS 135 may include a parser 210, an optimizer 220, an execution engine 230, and a database 232. The parser 210 may receive a database query 145 from an application 150. In some embodiments, the database query 145 may be in the form of a Structured Query Language (SQL) statement. The parser 210 may generate a parsed statement 215. The parser 210 may send the parsed statement 215 to an optimizer 220. The optimizer 220 may attempt to optimize the parsed statement. In some embodiments, optimizing may improve the performance of the database query 145 by, for example, reducing the amount of time it takes to provide a user with a response. The optimizer 220 may generate an execution plan 246 (access plan), which may be maintained in a query plan cache 245, according to some embodiments. The query plan cache 245 may include one or more execution plans 246, including the current execution plan as well as previously used execution plans. Once an execution plan 246 is generated, the execution plan 246 may be sent to the execution engine 230. The execution engine 230 may execute the query 145. Executing the query 145 may include finding and retrieving data in the database tables 235 that satisfies the criteria supplied in the query 145. The execution engine 230 may store the data returned matching the query 145 in a result set 140. The DBMS 135 may return the result set 140 to an application 150, such as the application in which the database query 145 was generated, as a response to the database query 145.

A database 232 may include one or more tables 235 and, in some embodiments, one or more indexes 240. A database table 235 may organize data into rows and columns. Each row of a database table 235 may correspond to an individual entry, a tuple, or a record in the database 232. A column may define what is stored in each entry, tuple, or record. In some embodiments, columns of a table 235 may also be referred to as fields or attributes. Each table 235 within the database 232 may have a unique name. Each column within a table 235 may also have a unique name. A row, tuple, or record, however, within a particular table 235 may not be unique, according to some embodiments. A database 232 may also include one or more indexes 240. An index 240 may be a data structure that may inform the DBMS 135 of the location of a particular record within a table 235 if given a particular indexed column value. In some embodiments, the execution engine 230 may use the one or more indexes 240 to locate data within a table 235. In other embodiments, the execution engine 230 may scan the tables 235 without using an index 240.

As mentioned herein, the optimizer 220 creates the query access plan. The optimizer 220 may be implemented as computer program instructions that optimize the access plan in dependence upon database management statistics. Database statistics may reveal, for example, that there are only two identification values in a transactions table—so that it is an optimization, that is, more efficient, to scan the transactions table rather than using an index. Alternatively, database statistics may reveal that there are many transaction records with only a few transaction records for each identification value—so that it is an optimization, that is, more efficient, to access the transaction records by an index.

In addition, the optimizer 220 builds a query cursor from the query access plan. Query cursors are associated with multirow queries. Query cursors also can be associated with single row queries. A multirow query is a query that returns more than one row and its execution is handled in two stages. First, the program starts the query, although no data is returned immediately. Then, the program requests the rows of data one at a time or may be requested in blocks of rows at a time.

These operations are performed using a special data object called a “cursor”. A cursor is an executable data structure that represents the state of a query, either single row or multirow, and is built from a query access plan. The following description shows a general set of program operations.

The program declares the cursor and its associated SELECT statement, which allocates storage to hold the cursor. The program opens the cursor, which starts the execution of the associated SELECT statement and detects any errors in it. The program fetches a row of data into host variables and processes it. In certain embodiments, the program can close the cursor after the last row is fetched. In various embodiments, when the cursor is no longer needed, the program can free the cursor and resources. In various embodiments, the cursor may be kept for usage by other jobs that run a same/similar query. In various embodiments, as described herein, different queries may use a same cursor which may have derived from/arisen out of a different job or derived from/arisen out of a different query (syntax or semantic). As such, savings may result with respect to creating cursors and optimization processing resources.

These operations may, for example, be performed with SQL statements named DECLARE, OPEN, FETCH, CLOSE, and FREE. Thus, an open query cursor, which is sometimes referred to as an open data path (ODP), is the object built by the optimizer 220 when a user or application program issues an SQL OPEN statement, and is the live object which returns rows when a user or application program issues an SQL FETCH statement. Although SQL is a common interface, other interfaces such as QUERY, DDL, XML, etc. may be used to perform the requisite operations.

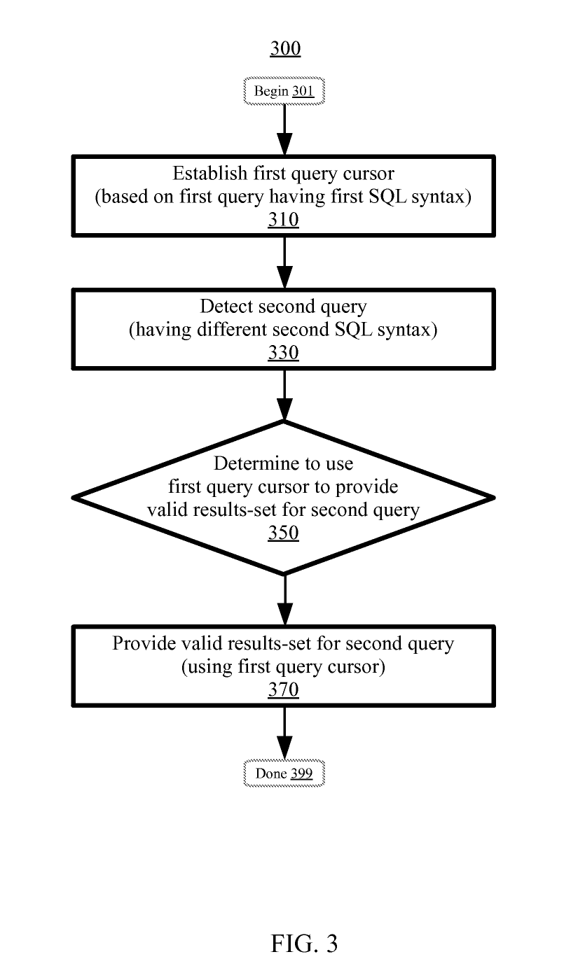

FIG. 3 is a flowchart illustrating a method 300 for query cursor management according to embodiments. Query cursor management can include utilizing a pool of query cursors to process at least a portion of a group of jobs/queries (e.g., by reusing one or more established query cursors). For example, open cursors may use a not-insignificant portion of resources; instead of arbitrarily choosing/utilizing a value to limit the number of open query cursors per job, such query cursors may be reused by different jobs or different queries. Method 300 may begin at block 301.

At block 310, a first query cursor is established. The first query cursor is based on a first query. The first query has a first Structured Query Language (SQL) syntax. Establishing the first query cursor can include creating a new data structure, generating a set of data for storage, structuring a sorted configuration of data, constructing benchmarks for measurement, outputting a packaged cursor, forming a cursor to fit a particular function, or organizing one or more contents of a set of data. The first query may have various syntactic and semantic components (where the first SQL syntax is different/distinct from the second SQL syntax with respect to block 330).

At block 330, a second query is detected. The second query has a second SQL syntax. The second SQL syntax differs from the first SQL syntax. Detecting the second query can include receiving a transmitted data packet or sensing a request for information. The second SQL syntax may be different from the first SQL syntax with respect to a variety of factors. Factors may include illustrative examples/combinations such as SELECT statements, FROM clauses, JOIN subclauses, WHERE clauses, GROUP BY clauses, HAVING clauses, or a nested factor (e.g., subqueries). Syntactic/semantically different queries may be distinct from a mere change in parameter markers/literals (e.g., non-host variable versus host variables). Consider an example with different host variable values such as a first query having a syntax of: “WHERE State=?” and the first time it is run with ‘MN’, but a subsequent time it is run with ‘WI’.

At block 350, it is determined to use the first query cursor to provide a valid results-set for the second query. The determination is made based on a relationship of the second query with respect to the first query cursor. For example, if the first query cursor includes a first feature and if the second query includes a second feature, then the relationship may include the first feature matching the second feature (e.g., first feature identical with second feature). The first and second features may be common SELECT statements using common FROM clauses, for example. The first query having an ORDER BY clause and the second query not having the ORDER BY clause may still yield the valid results-set for the second query. The relationship may be used to make the determination by performing a comparison (e.g., relating an assessment of a plurality of aspects) or evaluation (e.g., generating an appraisal of a totality of information). The relationship can include various similarities in the queries including factors listed herein (e.g., the variety of factors with respect to block 330). Similarity/relatedness/relevancy may be scaled, scored, or weighted such that a similarity/relatedness/relevancy of two queries which meets a threshold thereby yields use of an established query cursor.

At block 370, the valid results-set for the second query is provided. The first query cursor is used to provide the valid results-set for the second query. Providing the valid results-set for the second query can include routing the valid results-set to the originator of the second query, processing an output with respect to the valid results-set, returning the valid results-set to a cursor manager list, or displaying at least a portion of a valid results-set (e.g., to a user). The tangible output results for the first and second queries may be different due to different inputs, but such results would be valid. As such, a different query may use a previously established cursor to gain results in an efficient manner (e.g., even though the query is different a cursor developed for another purpose it may return valid results). In certain instances, the results may be substantively the same (e.g., same content/information) in a different form/organization (e.g., different order).

For instance, consider the following example. A first example query (QUERY1) may include: “SELECT Column#1 > FROM TABLE#1 > WHERE Column#2=:HV1 > ORDER BY Column#3 --> Create CURSOR QUERY1:”. In response to completion of the first example query, the cursor object can be stored in a cursor manager list for reuse by a cursor manager. The cursor manager may map different queries to the same cursor and may optionally create or alter the result buffer to return correct, appropriate, or valid results with limited overhead compared to creating a new cursor (e.g., “Cursor QUERYx . . . Cursor QUERY1”).

Next, a second example query (QUERY2) may include: “SELECT Column#1 > FROM TABLE#1 > WHERE Column#2=:HV1”. Before creating a second cursor, the cursor manager can determine if an existing cursor matches the returned results in the cursor manager list. In this example, Cursor QUERY1 is a potential match for QUERY2. QUERY1 cursor can be used for returning QUERY2's results (e.g., a valid results-set would be returned though the results may be different if the inputs are different). In this example, the ORDER BY is not important to the results of the second query, so there is no need to create a new query cursor. As such, the cursor manager will check-out the existing cursor QUERY1 from the cursor manager list, use it for generating QUERY2 results, and return it to the cursor manager list when complete.

Method 300 concludes at block 399. Aspects of method 300 may provide performance or efficiency benefits with respect to query cursor management. For example, aspects of method 300 may include positive impacts on resource usage (e.g., memory) by (re)using established query cursors. Altogether, performance or efficiency benefits when managing one or more query cursors may occur (e.g., speed, flexibility, responsiveness, resource usage).

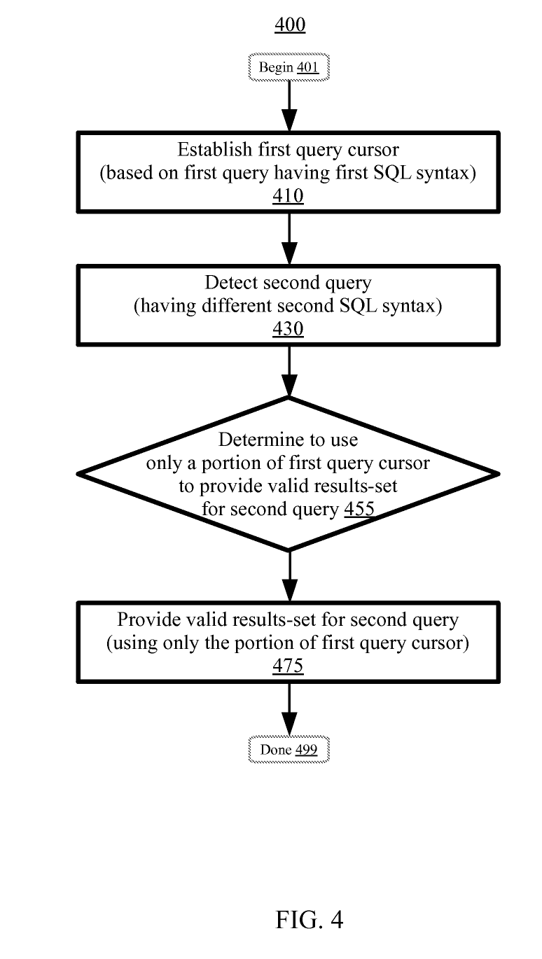

FIG. 4 is a flowchart illustrating a method 400 for query cursor management according to embodiments. Aspects of method 400 may be similar or the same as aspects of method 300. Method 400 may begin at block 401. At block 410, a first query cursor is established. The first query cursor is based on a first query. The first query has a first Structured Query Language (SQL) syntax. At block 430, a second query is detected. The second query has a second SQL syntax. The second SQL syntax differs from the first SQL syntax.

At block 455, it is determined to use the first query cursor to provide a valid results-set for the second query. The determination is made based on a relationship of the second query with respect to the first query cursor. By analyzing the relationship, it is determined that the second query needs only a portion of the first query cursor to provide a valid results-set for the second query.

At block 475, the valid results-set for the second query is provided. The first query cursor is used to provide the valid results-set for the second query. In response to determining that the second query needs only the portion of the first query cursor to provide the valid results-set for the second query, only the portion of the first query cursor is used to provide the valid results-set for the second query.

For example, consider a select list that has a subset of returned fields. When reusing a query cursor where the original buffer contains more columns than are needed for the second query, one or more fields in the original buffer may be ignored/disregarded/absent with respect to the valid results-set for the second query (e.g., ORDER BY columns which are not in the select list that has the subset of returned fields). For instance, if the first example query (QUERY1) includes “SELECT Column#1, Column#2 > FROM TABLE#1 > WHERE Column#1=:HV2 -->Create CURSOR QUERY1” and if the second example query (QUERY2) includes “SELECT Column#1 > FROM TABLE#1 > WHERE Column#1=:HV2”, then CURSOR QUERY1 can be used. As such, the original buffer may be returned as an altered buffered which does not include Column#2 (e.g., the cursor manager changes or ignores/disregards portions of the original buffer). Method 400 concludes at block 499.

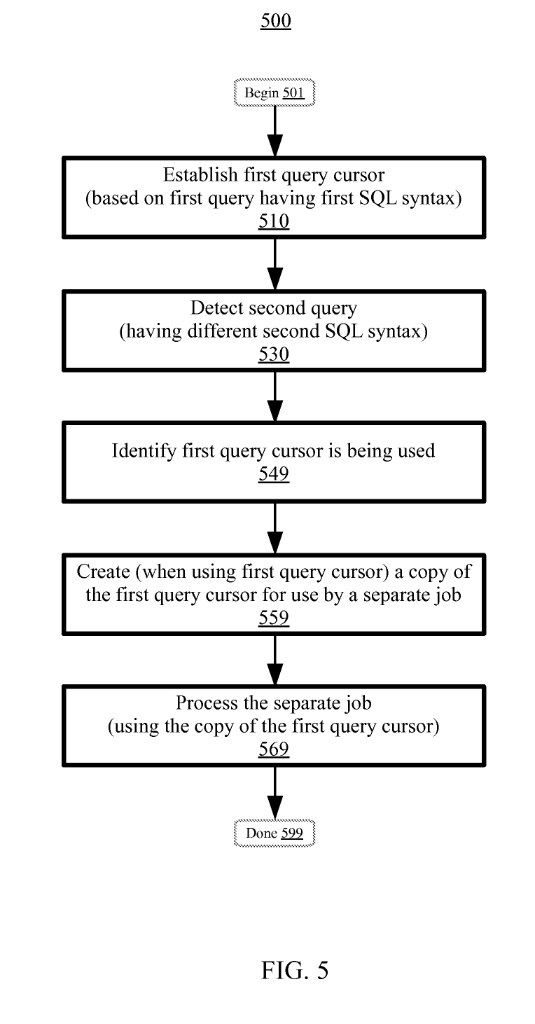

FIG. 5 is a flowchart illustrating a method 500 for query cursor management according to embodiments. Aspects of method 500 may be similar or the same as aspects of method 300. Aspects of method 500 can duplicate a query cursor which is in use by a first job to facilitate use by a second job. Method 500 may begin at block 501. At block 510, a first query cursor is established. The first query cursor is based on a first query. The first query has a first Structured Query Language (SQL) syntax. At block 530, a second query is detected. The second query has a second SQL syntax. The second SQL syntax differs from the first SQL syntax.

At block 549, it is identified that the first query cursor is being used (e.g., by a first job/query/process). Being used can include being run, executed, initiated, etc. Identification can included detection or ascertainment. When/while the first query cursor is being used a copy of the first query cursor is created at block 559. The copy of the first query cursor can be for use by a separate job (e.g., a second job/query/process). The copy may be added to a cursor manager list.

At block 569, the separate job can be processed using the copy of the first query cursor. As such, the original query cursor can continue processing the original/first job without incurring substantial performance or efficiency burdens while the second/separate job may experience performance or efficiency benefits by being able to process the job in a timely and efficient manner. As a whole, duplicating a query cursor which is in use by a first job to facilitate use by a second job can have a positive impact. Method 500 concludes at block 599.

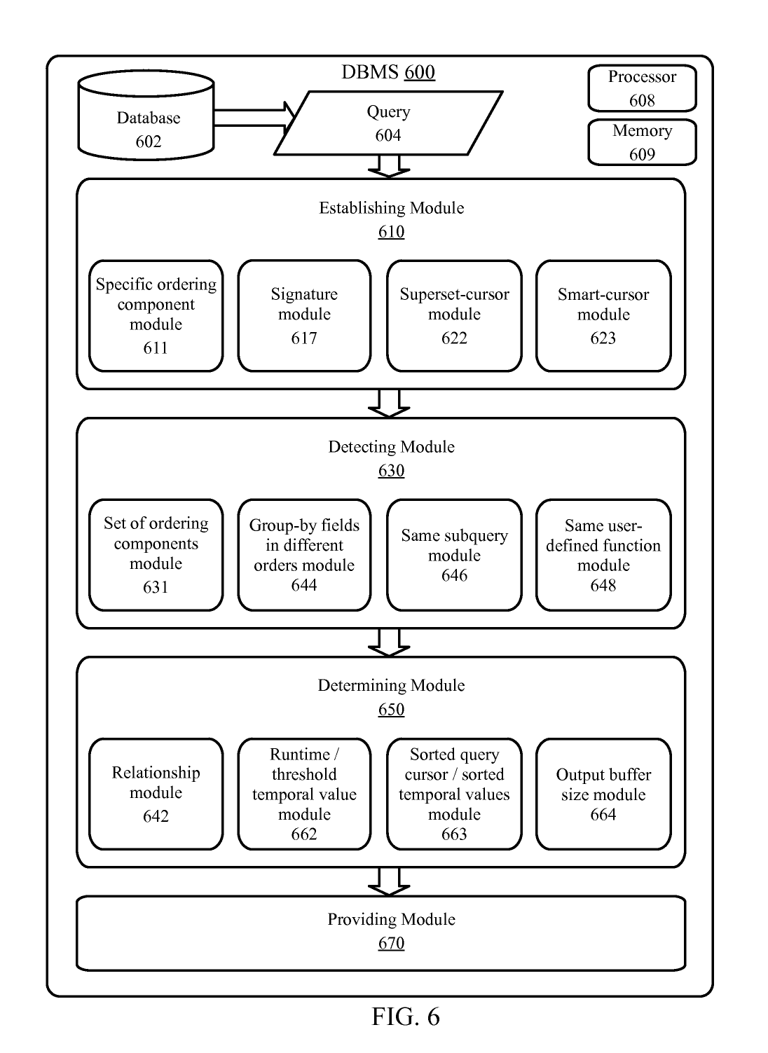

FIG. 6 shows an example system 600 for query cursor management according to embodiments. The example system 600 may illustrate a database management system (DBMS). The example system 600 includes a (computer/hardware) processor 608 and a memory 609. The example system 600 has a database 602 and has one or more queries 604. The one or more queries 604 may be used for operation(s) with respect to aspects described herein including methods 300, 400, 500 and the example system 600.

The example system 600 can include an establishing module 610 (see e.g., description with respect to block 310 of FIG. 3), a detecting module 630 (see e.g., description with respect to block 330 of FIG. 3), a determining module 650 (see e.g., description with respect to block 350 of FIG. 3), and a providing module 670 (see e.g., description with respect to block 370 of FIG. 3). As such, the example system 600 may implement aspects of method 300/400/500. In embodiments, other aspects may be included.

The establishing module 610 establishes a first query cursor (e.g., implemented with the processor 608). The first query cursor is based on a first query. The first query has a first Structured Query Language (SQL) syntax. In embodiments, a specific ordering component module 611 includes a specific ordering component in the first SQL syntax which is absent in the second SQL syntax. For example, an ORDER BY command may be present in the first SQL syntax but not present in the second SQL syntax. As such, the provided substantive results are not substantive different with respect to content (they are with respect to order). Thus, aspects of the disclosure may facilitate using a query cursor with ordering when ordering is not specified in the second SQL syntax.

In embodiments, a signature module 617 may store a signature. For instance, the first query cursor may be stored in a cache with a signature. The signature may be based on at least one of: a parsed SQL statement, an SQL tokenization, a token tree comparison, a table analysis, or a column bitmap. The signature may be useful when searching for a compatible query cursor with respect to a submitted query yet to be fully processed. The signature may indicate relevancy, compatibility, or contextual similarity. In various embodiments, the signature may be used in a catalog/directory/library/list for efficient locating/anticipation of an appropriate query cursor. Such a catalog may be developed using historical data, current information, or future projections to identify useful query-cursor/query combinations.

In embodiments, the superset-cursor module 622 can establish the first query cursor based on both the first query having the first SQL syntax and the second query having the second SQL syntax. As such, a cursor manager may analyze cursors in a creation phase. A MACRO cursor may be built/formed which can fulfill a plurality of cursor requests from a database. Thus, the plurality of cursor requests may be satisfied with a same cursor which has (already) been created. Such functionality may be useful even if only one job is on the system (e.g., multiple queries).

For example, consider three example queries where QUERY1 includes “SELECT Column#1 > FROM TABLE#1 > WHERE Column#2=:HV3”, QUERY2 includes “SELECT Column#2 > FROM TABLE#1 > WHERE Column#2=:HV3 > ORDER BY Column#1, Column#2”, and QUERY3 includes “SELECT Column#8 > FROM TABLE#1 > WHERE Column#2=:HV3 > ORDER BY Column#1, Column#2, Column#3”. Accordingly, an example resulting cursor representation can use Column#1, Column#2, Column#8 to map results fields. The cursor manager may tweak a result buffer to indicate which fields are to be returned to the requester/caller. TABLE#1 may indicate the one or more tables involved. Column#2=:HV3 represent matching of the selection and/or join selection. With respect to, Column#1, Column#2, Column#3—ordering may be built such that it will match/fulfill ordering of the requesting queries. The example represents one possible implementation with respect to the super-set cursor module, others are contemplated.

In embodiments, the smart-cursor module 623 may establish the first query cursor based on both the first query having the first SQL syntax and the second query having the second SQL syntax. Also, the smart-cursor module 623 may structure, into the first query cursor, both a first selection specification from the first SQL syntax and a second selection specification from the second SQL syntax. The smart-cursor module 623 may generate a dynamic cursor which gets/obtains/enables/meshes additional query(s) to correspond with (e.g., match) the first query cursor (e.g., using the first query cursor but adding a selection mechanism so as to modify the first query cursor).

As such, case selection specification(s) may be built into the first query cursor to satisfy varying/different selection conditions to increase the (quantity of) queries that match or correspond with the first query cursor. For example, consider three example queries where QUERY1 includes “SELECT.. > FROM .... > WHERE Column#1=:HV4”, QUERY2 includes “SELECT.. > FROM .... > WHERE Column#2=:HV4”, and “SELECT.. > FROM .... > WHERE Column#3=:HV4”. To illustrate, CURSOR selection may be built/formed/created/generated so as to include “SELECT.. > FROM .... > WHERE (CASE >> WHEN QUERY1 THEN Column#1=:HV4 ˜ WHEN QUERY2 THEN C2=:HV4 ˜ ELSE C3=:HV4 >> END)”.

The detecting module 630 detects a second query (e.g., implemented with the processor 608). The second query has a second SQL syntax. The second SQL syntax differs from the first SQL syntax. In embodiments, a set of ordering components module 631 has the second SQL syntax that includes a set of ordering components which are all included in the first SQL syntax. For example, the second SQL syntax may include a subset of ORDER BY fields of the first SQL syntax. For instance, the first SQL syntax may include “ORDER BY Column#1, Column#2, Column#3” and the second SQL syntax may include “ORDER BY Column#1, Column#2”. As such, the valid results-set would be produced/provided by the first query cursor according to embodiments. In another example, another second SQL syntax may include “ORDER BY Column#1”. Accordingly, aspects of the example system 600 may use/check the signature associated with the first query cursor.

In embodiments, the set of ordering components module 631 has the second SQL syntax that includes a set of ordering components which is not included in the first SQL syntax. For instance, the first query cursor may be without an ordering criteria (e.g, QUERY1 ˜ “SELECT FROM TABLE4 WHERE myID=?”). The second query may include the ordering criteria (e.g., QUERY2 ˜ “SELECT FROM TABLE4 WHERE myID=? ORDER BY Column#4 //IF myID unique”). As such, it may be known that the second query will return only one row; ordering would not matter and can effectively be dropped. The first query cursor may be used.

In embodiments, a group-by fields in different orders module 644 includes both the first query cursor which has a set of group-by fields in a first order and the second query which has the set of group-by fields in a second order. In the group-by fields in different orders module 644 the first order mismatches the second order. For example, utilizing a GROUP BY command the same group by fields in different order can be reused (e.g., “GROUP BY CityColumn and then StateColumn” can be reused to “GROUP BY StateColumn and then CityColumn”). As such, substantive contents returned may be the same (e.g., but may be in a different order based on the parameters used).

In embodiments, a same subquery module 646 includes both the first query cursor and the second query having a same subquery. As such, the first query cursor may be used to fulfill/process one or more subqueries (e.g., a subquery valid results-set). For example, consider if QUERY1 includes “SELECT Column#1 > FROM TABLE#1 > WHERE Column#1=:HV5 --> Create CURSOR QUERY1:” and QUERY2 includes “SELECT Column#4 > FROM TABLE#2 > WHERE Column#4=(SELECT Column#1 > FROM TABLE#1 > WHERE Column#1=:HV5)”. In the example, CURSOR QUERY1 may be used in place of a corresponding portion of QUERY2 (i.e., SELECT Column#1 > FROM TABLE#1 > WHERE Column#1=:HV5).

In embodiments, a same user-defined function module 648 includes both the first query cursor and the second query having a same user-defined function. Aspects of the same user-defined function module 648 and aspects of the same subquery module 646 may be the same or similar. As such, the first query cursor may be used to fulfill/process one or more user-defined functions. For instance, if a user-defined function runs a query (or a query cursor) and a matching/relevant query cursor exists, the matching/relevant query cursor may be used for the query.

The determining module 650 determines to use the first query cursor to provide a valid results-set for the second query (e.g., implemented with the processor 608). The determination is made based on a relationship of the second query with respect to the first query cursor. In embodiments, a relationship module 642 may specify the relationship. For example, if the first query cursor includes a first feature and if the second query includes a second feature, then the relationship may include the first feature matching the second feature. As such, the relationship can include at least one feature being the same, identical, or matching.

In embodiments, the relationship may be associated with the signature (described herein). For example, one or more features may at least correlate to at least a component of the signature. For instance, group-by ‘city-state’ and group-by ‘state-city’ have at least two correlated/same features (i.e., state and city). In certain embodiments, the relationship may have a comparison, an evaluation, or data analysis. Data analysis may include a process of inspecting, cleaning, transforming, or modeling data to discover useful information, suggest conclusions, or support decisions. Data analysis can extract information/patterns from a data set and transform/translate it into an understandable structure (e.g., a data compilation which can be provided/routed) for further use. For instance, analyzing can include extracting (e.g., creating a derivation), examining (e.g., performing an inspection), evaluating (e.g., generating an appraisal), dissecting (e.g., scrutinizing an attribute), resolving (e.g., ascertaining an observation/conclusion/answer), parsing (e.g., deciphering a construct), querying (e.g., asking a question), searching (e.g., exploring for a reason), comparing (e.g., relating an assessment), classifying (e.g., assigning a designation), or categorizing (e.g., organizing by a particular element).

One or more mechanisms may be utilized to determine how a usable cursor (e.g., returns valid/correct results) may impact performance or efficiency. In embodiments, a runtime/threshold temporal value module 662 (which can be utilized in determining to use the first query cursor) includes determining a runtime of the first query cursor is below a threshold temporal value. The runtime may be an estimated runtime (e.g., projected for a job yet to be run) or an actual runtime (e.g., based on current/historical data). Previous estimated or actual runtime of the first query cursor may be checked/analyzed to determine/ascertain/resolve if the first query cursor is a good candidate to reuse (e.g., based on a reuse score which may be weighted). If the first query cursor ran quickly then it may be reused. If the first query cursor is very slow (e.g., slow below a threshold), then checking/searching for a better/faster plan may occur. In certain embodiments, performance or efficiency benchmark(s) of the query (e.g., first page, one or more rows) may be analyzed to determine correspondence with respect to requirement(s) of the incoming query.

In embodiments, a sorted query cursor/sorted temporal values module 663 includes the first query cursor being sorted and the runtime of the first query cursor has a first sorting temporal value below a threshold sorting temporal value. For example, if a sorted query cursor is reused for a received/requested non-sorted query, analysis of the query estimates or actual runtimes of the cursor may occur (e.g., be performed/executed). Such analysis may ascertain a quantity with respect to resources spent (e.g., time, processing, memory) specifically in the sorting phase (e.g., performing the sort). If resources spent exceed a threshold, then it may be more efficient to build a new query plan and cursor. However, when the sort phase is negligible or non-existent the existing cursor can be used (e.g., when sorting via index).

In embodiments, an output buffer size module 664 (which can be utilized in determining to use the first query cursor) includes determining an output buffer size of the first query cursor is below a threshold buffer size. For example, consider if a potential cursor returns a large field (e.g., a large object datatype, a large varchar) or many columns. The large output may not be needed for the incoming query. As such, it may be more efficient to build a new query plan and cursor (e.g., use resources such as memory more efficiently).

The providing module 670 provides the valid results-set for the second query (e.g., implemented with the processor 608). The first query cursor is used to provide the valid results-set for the second query. Aspects of the example system 600 may provide performance or efficiency benefits with respect to query cursor management (e.g., speed, flexibility, responsiveness, resource usage).

In addition to embodiments described above, other embodiments having fewer operational steps, more operational steps, or different operational steps are contemplated. Also, some embodiments may perform some or all of the above operational steps in a different order. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

Embodiments of the present disclosure may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

1. A computer-implemented method for query cursor management, the method comprising:
establishing, based on a first query having a first Structured Query Language (SQL) syntax, a first query cursor;
detecting a second query having a second SQL syntax which differs from the first SQL syntax;
determining, based on a relationship of the second query with respect to the first query cursor, to use the first query cursor to provide a valid results-set for the second query; and
providing, using the first query cursor, the valid results-set for the second query.

2. The method of claim 1, wherein query cursor management includes utilizing a pool of established query cursors to process at least a portion of: one or more jobs, or one or more queries.

3. The method of claim 1, wherein:
the first query cursor includes a first feature;
the second query includes a second feature; and
the relationship includes the first feature matching the second feature.

4. The method of claim 1, wherein the first SQL syntax includes a specific ordering component which is absent in the second SQL syntax.

5. The method of claim 1, wherein the second SQL syntax includes a set of ordering components which is included in the first SQL syntax.

6. The method of claim 1, wherein the second SQL syntax includes a set of ordering components which is not included in the first SQL syntax.

7. The method of claim 1, further comprising:
determining, by analyzing the relationship, the second query needs only a portion of the first query cursor to provide the valid results-set for the second query; and
providing, using only the portion of the first query cursor, the valid results-set for the second query.

8. The method of claim 1, wherein the first query cursor includes a set of group-by fields having a first order, the second query includes the set of group-by fields having a second order, and the first order mismatches the second order.

9. The method of claim 1, wherein both the first query cursor and the second query include a same subquery.

10. The method of claim 1, wherein both the first query cursor and the second query include a same user-defined function.

11. The method of claim 1, wherein determining to use the first query cursor includes: determining a runtime of the first query cursor is below a threshold temporal value, wherein the runtime is one of estimated or actual.

12. The method of claim 11, wherein the first query cursor is sorted, and wherein the runtime of the first query cursor has a first sorting temporal value below a threshold sorting temporal value.

13. The method of claim 1, wherein determining to use the first query cursor includes: determining an output buffer size of the first query cursor is below a threshold buffer size.

14. The method of claim 1, wherein establishing, based on the first query having the first SQL syntax, the first query cursor includes: establishing the first query cursor based on both the first query having the first SQL syntax and the second query having the second SQL syntax.

15. The method of claim 14, wherein establishing the first query cursor based on both the first query having the first SQL syntax and the second query having the second SQL syntax includes: structuring, into the first query cursor, both a first selection specification from the first SQL syntax and a second selection specification from the second SQL syntax.

16. The method of claim 1, further comprising:
identifying the first query cursor is being used;
creating, when using the first query cursor, a copy of the first query cursor for use by a separate job; and
processing, using the copy of the first query cursor, the separate job.

17. The method of claim 1, wherein establishing the first query cursor includes storing the first query cursor in a cache with a signature, the signature being based on a group consisting of at least one of: a parsed SQL statement, an SQL tokenization, a token tree comparison, a table analysis, or a column bitmap.

18-20. (canceled)
